(19) United States
(12) Patent Application Publication
(10) Pub. No.: US 2007/0089587 A1
(43) Pub. Date: Apr. 26, 2007

(54) Mechanism making braking lines for container caps

(76) Inventor: Chi-Ti Liao, Taichung County (TW)

Correspondence Address: LIAO, CHI-TI, P.O. Box 44-2049, Taipei, 10668, TW

(21) Appl. No.: 11/258,102

(22) Filed: Oct. 26, 2005

(51) Int. Cl. B26D 3/08

(52) U.S. Cl. 83/879; 83/733

(57) ABSTRACT

A mechanism for making breaking lines for container caps includes a main shaft and a plurality of driving shafts rotatably located around the main shaft. Each driving shaft spins about an axis thereof and moves up and down with the rotation of the main shaft. Each driving shaft includes a pressing plate and a push member. The driving shaft is lowered to position the caps and the pressing members bend the pressing plates of the caps which are then rotated by the rotation of the driving shafts and cut by the cutting device to form the breaking lines. The driving shafts move upward and the caps are then pushed by the pressing member to disengage from the driving shafts.

### BACKGROUND OF THE INVENTION

### Field of the Invention

The present invention relates to a mechanism for automatically making braking lines of container caps.

A container cap 1 is shown in FIGS. 1 and 2, and generally includes a open end and a close end so as to be threadedly connected to an opening of a container (both not shown). The cap 1 includes a serrated outer periphery 5 so that the user can easily hold the cap 1 and rotates the cap 1. A fastening portion 3 extends from a periphery of the cap 1 and a braking line 2 is defined between the fastening portion 3 and the portion that includes the serrated outer periphery 5. A plurality of pressing plates 4 extend from the periphery of the fastening portion 3 such that when the user rotates the cap 1, the pressing plates 4 perform an important friction role to hold the fastening portion 3 and the portion having the serrated outer periphery 5 of the cap 1 is then separated from the fastening portion 3 and can be removed from the opening of the container.

In order to make the braking line 2, a conventional mechanism for making the braking lines 2 is used and includes a curve blade to cut the breaking lines 2. The caps 1 are orientated such that the braking lines 2 are perpendicular to the horizontal plane and the curve blade cuts the braking lines 2. However, the conventional way cannot cut the breaking lines 2 evenly at desired positions and the speed for cutting the braking lines 2 is slow which cannot meet commercial requirements.

The present invention intends to provide a mechanism for automatically making braking lines of container caps and the mechanism has high efficiency and reliability.

### SUMMARY OF THE INVENTION

The present invention relates to a mechanism for making breaking lines for container caps comprises an input way connected to an input disk for feeding the caps into the mechanism. An output disk is connected to the mechanism and an output way connected thereto so that the caps with breaking lines are collected from the output way. A main shaft includes an upward path and a downward path defined in an outer periphery thereof, and a plurality of rotatable driving shafts are movably engaged with the upward path and the downward path. An upper rotatable disk and a middle rotatable disk with a plurality of positioning columns connected therebetween. The positioning columns are movable about the main shaft and each positioning column includes a driving shaft which spins about an axis thereof.

Each driving shaft has a pressing member with a rod extending from a top thereof and a push member is movably mounted on the rod. The push member has a skirt portion so as to enclose the pressing member. A gap is defined between the pressing member and the push member. A lower rotatable disk has a receiving groove defined in an outer periphery thereof and the input disk and the output disk communicate with the receiving groove. Each of the input disk and the output disk has a recess and a shifting member is received in the two respective recesses of the input disk and the output disk. A cutting device has a first clamp member and a second clamp member with a blade clamped therebetween. The blade is connected to a shank and the second clamp member has a serrated outer surface.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a container cap wherein the breaking line is not yet made;

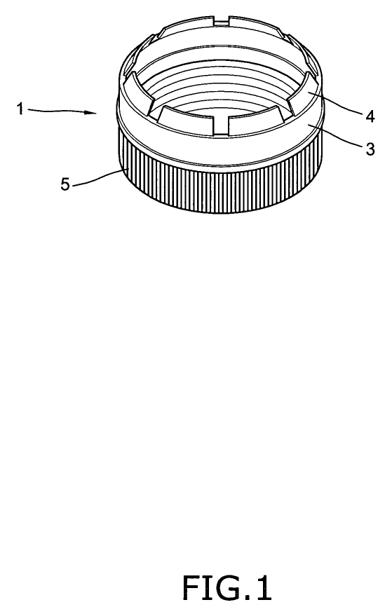

FIG. 2 shows that the container cap is made with the breaking line;

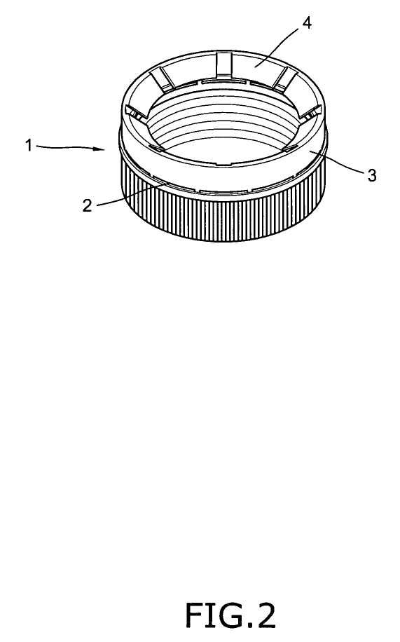

FIG. 3 is a perspective view to show the mechanism of the present invention;

FIG. 4 shows the input or the output disk of the mechanism of the present invention;

FIG. 5 shows a side view of the mechanism of the present invention;

FIG. 6 is an exploded view to show the driving shaft of the mechanism of the present invention;

FIG. 7 is a cross sectional view of the driving shaft of the mechanism of the present invention;

FIG. 8 is a top view of the mechanism of the present invention;

FIG. 9 is a perspective view to show the cutting device of the present invention;

FIG. 10 shows that the driving shaft is lowered to push the cap;

FIG. 11 shows the cap is disengaged from the driving shaft;

FIG. 12 shows a vacuum cap, and

FIG. 13 shows another embodiment of the driving shaft for cooperated with the vacuum cap.

### DETAILED DESCRIPTION OF THE PREFERRED EMBODIMENT

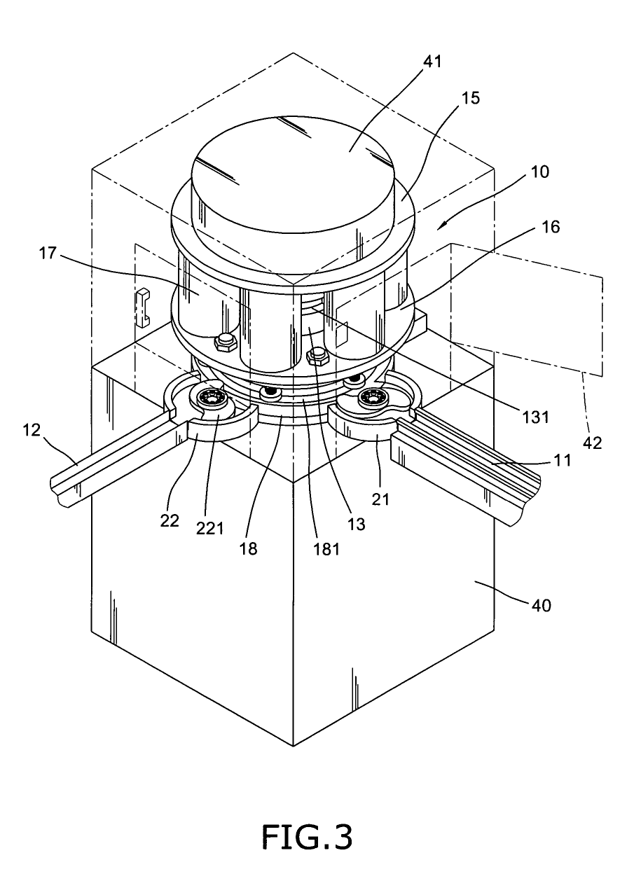

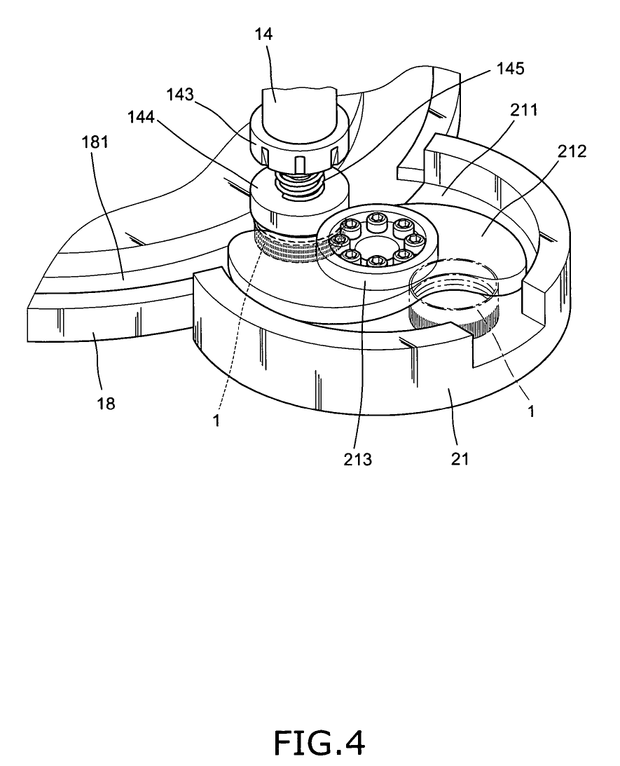

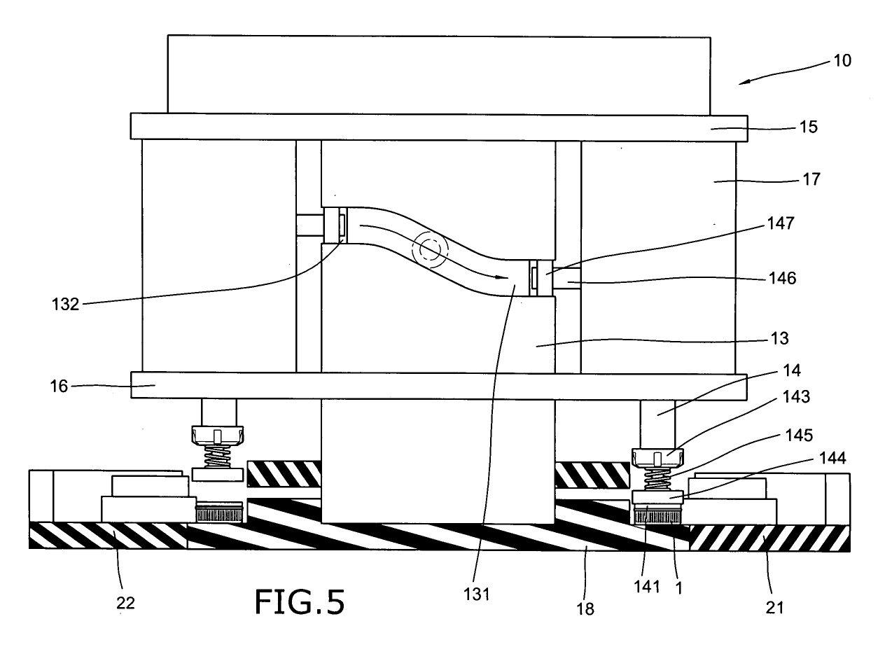

Referring to FIGS. 3 to 5, the mechanism 10 for making breaking lines 2 for container caps 1 which includes a serrated outer periphery 5 and a fastening portion 3 extends from a periphery of the cap 1 and a braking line 2 is defined between the fastening portion 3 and the portion that includes the serrated outer periphery 5. A plurality of pressing plates 4 extend from the periphery of the fastening portion 3.

The mechanism 10 for making breaking lines 2 for container caps 1 comprises a base case 40 in which a motor (not shown) is received and a main shaft 13 includes an upward path 131 and a downward path 132 defined in an outer periphery thereof. The main shaft 13 is driven by the motor in the base case 40.

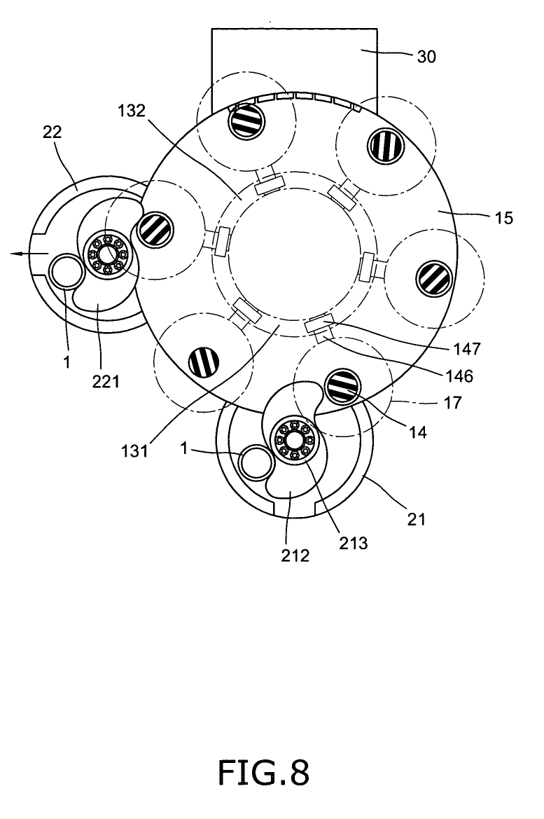

An upper rotatable disk 15 and a middle rotatable disk 16 with a plurality of positioning columns 17 connected between the upper and middle rotatable disks 15, 16. The positioning columns 17 are movable about the main shaft 13 and each positioning column 17 includes a driving shaft 14 which spins about an axis thereof. The driving shafts 14 rotate about the main shaft 13 with rotation of the upper and middle rotatable disks 15, 16. Further referring to FIG. 8, each driving shaft 14 has a rotatable extension 146 which extends out from the positioning column 17. Each rotatable extension 146 has a roller 147 connected thereto which is engaged with the upward and downward grooves 131, 132 of the main shaft 13.

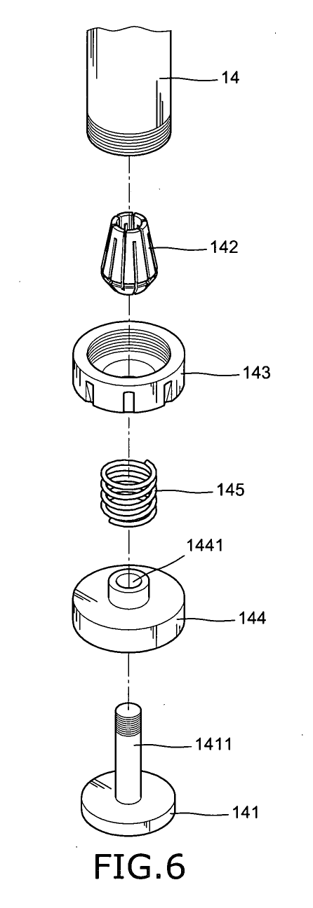

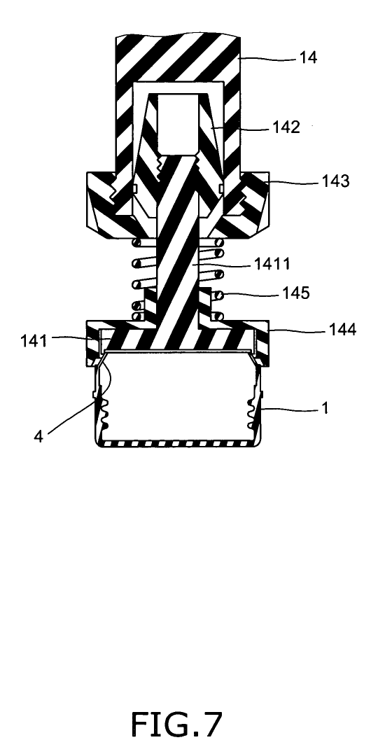

Referring to FIGS. 6 and 7, each driving shaft 14 has a pressing member 141 with a rod 1411 extending from a top thereof and a push member 144 is movably mounted on the rod 1411 by extending the rod 1411 through a hole 1441 in the push member 144. The push member 144 has a skirt portion so as to enclose the pressing member 141, a gap defined between the pressing member 141 and the push member 144. A cone-shaped expandable member 142 is received in each driving shaft 14 and threadedly connected to the rod 1411 on the pressing member 141. A collar 143 is threaded connected to an outside of each driving shaft 14 and a spring 145 is mounted on the rod 1411 and biased between the collar 143 and the push member 144 so that the push member 144 is movable relative to the pressing member 141 by the spring 145.

A lower rotatable disk 18 has a receiving groove 181 defined in an outer periphery thereof and an input disk 21 together with an input way 11 are connected to the lower rotatable disk 18 and communicate with the receiving groove 181. The caps 1 with the breaking lines are fed into the mechanism form the input way 11 and the input disk 21. An output disk 22 communicating with the receiving groove 181 and an output way 12 are connected to the output disk 22 so that the caps 1 that are made with the breaking lines 2 are sent out from the output disk 22 and the output way 12. Each of the input disk 21 and the output disk 22 has a recess 211 and a shifting member 212/221 is received in the two respective recesses 211 of the input disk 21 and the output disk 22. Each of the shifting member 212, 221 includes two curved shifting ends which have opposite curvatures.

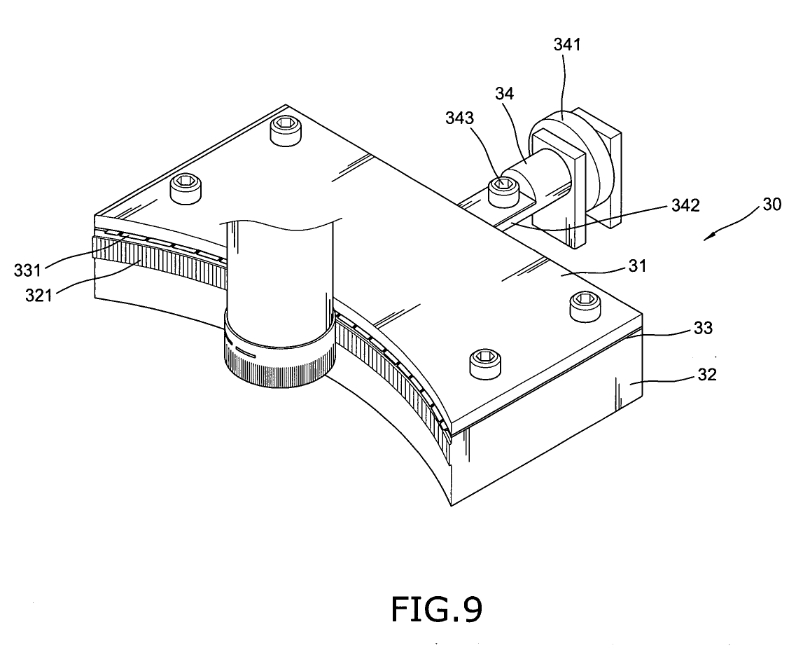

Further referring to FIGS. 8 and 9, a cutting device 30 is located opposite to the input disk 21 and has a first clamp member 31 and a second clamp member 32. A blade 33 is clamped between the first and second clamp members 31, 32. The blade 33 is connected to a shank 34 which includes a connection portion 342 on which the blade 33 is connected by a bolt 343. The blade 33 includes a plurality of cutting edges 331. An adjustment button 341 is threadedly connected to the connection portion 342 of the shank 34 so as to micro-adjust the connection portion 342. The second clamp member 32 has a serrated outer surface 321. The second clamp member 32 has a heating device received therein so as to make the blade 33 to have proper temperature to make the breaking lines 2.

A transparent cover 41 is mounted on the base case 40 and has four doors 42. Each door 42 has a limit switch so that when either one of the doors 42 is opened, the motor is stopped for safety reasons.

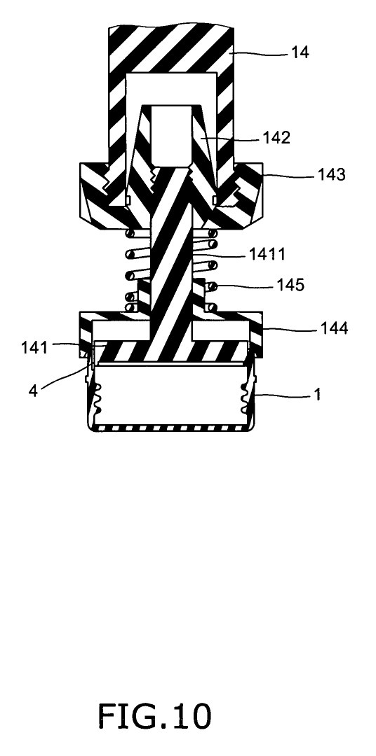

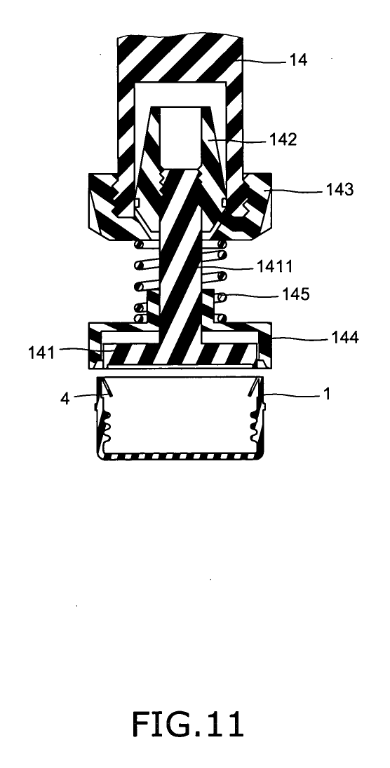

Referring to FIGS. 7, 10, and 11, the caps 1 that have not made with the breaking lines 2 are fed into the mechanism form the input disk 21 and are shifted by the shifting member 212 for 180 degrees and sent into the receiving groove 181. The driving shaft 14 is lowered within the downward path 131 to position the cap 1. The pressing member 141 presses inward the pressing plates 4 of the cap 1. The push member 144 is then pushed to move upward slightly. The driving shafts 14 spin and move around the main shaft 13. When the driving shafts 14 move to the cutting device 30, the serrated outer peripheries 5 of the caps 1 are in contact with the serrated outer surface 321 of the second clamp member 32, and the caps 1 are cut by the cutting edges 331 to form the braking lines 2. After the braking lines 2 are made, the caps 2 are sent the output disk 22 by the movement of the driving shafts 14. The driving shafts 14 are moved upward by the upward path 132 when moved in front of the output disk 22. The push member 144 is biased downward by the spring 145 and push the cap 1 to disengage from the driving shaft 14. The cap 1 drops into the output disk 22 and is shifted by the shifting member 221 and collected via the output way 12. The caps 1 are well positioned during the processes of moving and cut one by one so that the speed for making the breaking lines can be fast and the result is reliable.

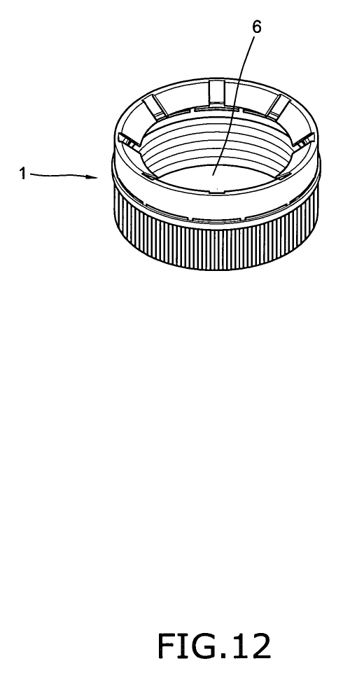

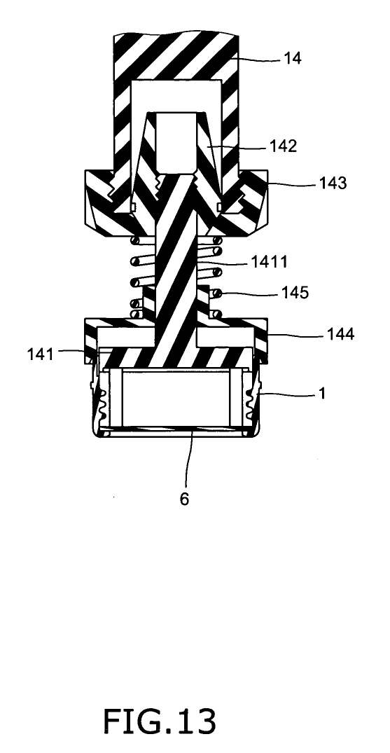

As shown in FIGS. 12 and 13, when used for the vacuum caps 6 as shown, the only change for the mechanism is that the pressing member 141 of each of the riving shafts 14 has an extension portion 142 extending therefrom so as to push the vacuum caps 6.

While we have shown and described the embodiment in accordance with the present invention, it should be clear to those skilled in the art that further embodiments may be made without departing from the scope of the present invention.

What is claimed is:

1. A mechanism for making breaking lines for container caps, comprising:
an input way connected to an input disk;
an output way connected to an output disk;
a main shaft including an upward path and a downward path defined in an outer periphery thereof, a plurality of rotatable driving shafts movably engaged with the upward path and the downward path;
an upper rotatable disk and a middle rotatable disk, a plurality of positioning columns connected between the upper and middle rotatable disks, the positioning columns movable about the main shaft and each positioning column including a driving shaft which spins about an axis thereof, each driving shaft having a pressing member with a rod extending from a top thereof and a push member movably mounted on the rod, the push member having a skirt portion so as to enclose the pressing member, a gap defined between the pressing member and the push member;
a lower rotatable disk having a receiving groove defined in an outer periphery thereof, the input disk and the output disk communicating with the receiving groove, each of the input disk and the output disk having a recess and a shifting member received in the two respective recesses of the input disk and the output disk, and
a cutting device having a first clamp member and a second clamp member, a blade clamped between the first and second clamp members, the blade connected to a shank, the second clamp member having a serrated outer surface.

2. The mechanism as claimed in claim 1 further comprising a base case which is adapted to receive a motor for driving the main shaft and a transparent cover mounted on the base case, the transparent cover has four doors.

3. The mechanism as claimed in claim 1, wherein each driving shaft has a rotatable extension which extends out from the positioning column, each rotatable extension has a roller connected thereto which is engaged with the upward and downward grooves of the main shaft, the driving shafts rotate about the main shaft with rotation of the upper and middle rotatable disks.

4. The mechanism as claimed in claim 1 further comprising an expandable member received in each driving shaft and threadedly connected to the rod on the pressing member, a collar threaded connected to an outside of each driving shaft and a spring biased between the collar and the push member so that the push member is movable relative to the pressing member by the spring.

5. The mechanism as claimed in claim 1, wherein each of the shifting member includes two curved shifting ends which have opposite curvatures.

6. The mechanism as claimed in claim 1, wherein the shank includes a connection portion on which the blade is connected by a bolt, an adjustment button is threadedly connected to the connection portion of the shank so as to micro-adjust the connection portion.

7. The mechanism as claimed in claim 1, wherein the second clamp member has a heating device received therein.

8. The mechanism as claimed in claim 1, wherein each driving shaft has an extension portion extending from the pressing member.
